(19) United States
(12) Patent Application Publication
(10) Pub. No.: US 2010/0162903 A1
(43) Pub. Date: Jul. 1, 2010

(54) GRILL

(75) Inventors: Dongmei Chen, Fujian Province (CN); Yang Zhou, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/650,905

(22) Filed: Dec. 31, 2009

(30) Foreign Application Priority Data
Dec. 31, 2008 (CN) 200820136684.8

(51) Int. Cl. A47J 37/06

(52) U.S. Cl. 99/422; 219/443.1

(57) ABSTRACT

The present invention discloses a grill, comprising: an upper baking pan unit and a lower baking pan unit. Said upper baking pan unit comprises an upper baking pan, a first bottom wall and a first peripheral wall, and said lower baking pan unit comprises a lower baking pan, a second bottom wall and a second peripheral wall. At least one of the first bottom wall and/or the second bottom wall comprises multiple convex units disposed on its front surface. Said convex units insert food when in cooking and accelerate the cooking time.

### TECHNOLOGY FIELD

The present invention relates to a grill.

### BACKGROUND OF THE INVENTION

The baking pan available in the market, for example, the baking pan of the grill, which includes a bottom wall and a peripheral wall extended upwardly from the edge of said bottom wall. In order to cook a delicious food, and the shape of the bottom wall is into wave shape, so multiple ribs are disposed at intervals. In cooking, such as cooking hamburger meat, we use the baking pan to press food to heat it in the grill, and only the baking pan is in contact with the top and the bottom of the hamburger meat, so the heating rate is relatively slow.

### SUMMARY OF THE INVENTION

This present invention is to provide a grill and baking pan, which overcome the disadvantage that the heating rate of the grill is relatively slow in background art.

The present invention adopts the one of the following technical solutions:

A grill comprises: an upper baking pan unit and a lower baking pan unit, wherein said upper baking pan unit comprises an upper baking pan, a first bottom wall and a first peripheral wall, and said lower baking pan unit comprises a lower baking pan, a second bottom wall and a second peripheral wall; wherein at least one of said first bottom wall and/or second bottom wall comprises multiple convex units disposed on its front surface.

In the preferred embodiment based on present invention, the front surface of said first bottom wall is into wave shape, and comprises multiple ribs disposed at intervals, wherein said convex units are disposed on said ribs uniformly.

In the preferred embodiment based on present invention, the front surface of said second bottom wall is into wave shape, and comprises multiple ribs disposed at intervals, wherein said convex units are disposed on said ribs uniformly.

In the preferred embodiment based on present invention, the end of said convex unit is tapered.

In the preferred embodiment based on present invention, said convex unit is a cylinder, and the end of said cylinder is tapered.

In the preferred embodiment based on present invention, the front surface of said second bottom wall is into wave shape and is the same as the front surface of said first bottom wall.

The present invention adopts the other of the following technical solutions:

A grill comprises: a baking pan provided with a bottom wall and a peripheral wall, wherein multiple convex units are disposed at intervals on the front surface of said bottom wall.

In the preferred embodiment based on present invention, the front surface of said bottom wall is into wave shape, and comprise multiple ribs disposed at intervals, wherein said convex units are disposed uniformly on said ribs.

In the preferred embodiment based on present invention, the end of said convex unit is tapered.

In the preferred embodiment based on present invention, said convex unit is a cylinder, and the end of said cylinder is tapered.

In the preferred embodiment based on present invention, said baking pan is integrative.

The present technical solution as compared with the background art: As the convex units are provided on the ribs, said convex units insert food in cooking, and these convex units transmit heat to food, accelerate the cooking time. Since the ribs and convex units are provided, so the strip-shaped burnt portion exists on the surface of food. the end of said convex unit is tapered, it is convenient for inserting into the inner of food.

### BRIEF DESCRIPTION OF THE DRAWINGS

The present invention will be further explained with the drawings and the embodiments.

FIG. 1 is a perspective view of the grill of the first preferred embodiment.

FIG. 2 is a sectional view of the grill of the first preferred embodiment.

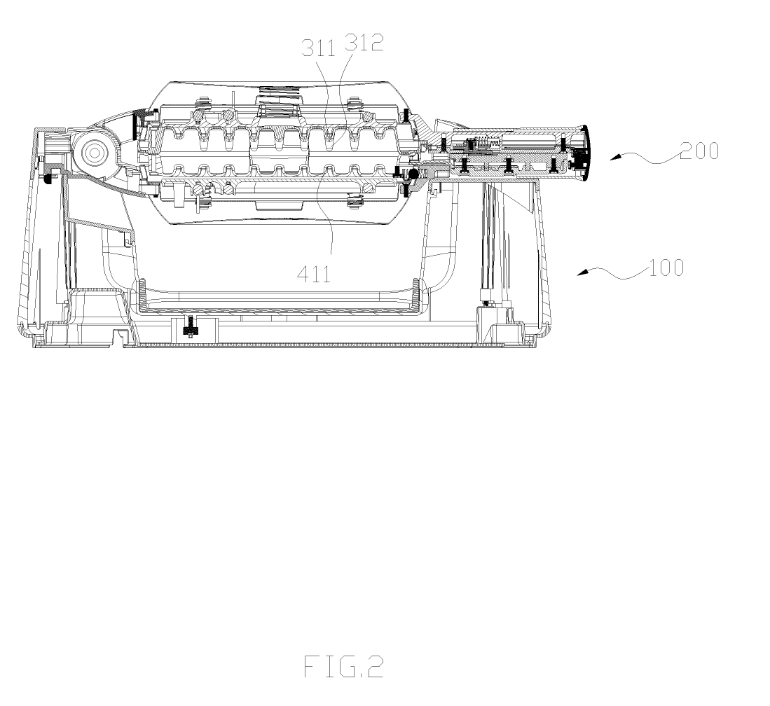

FIG. 3 is a perspective view of the upper baking pan of the grill of the first preferred embodiment.

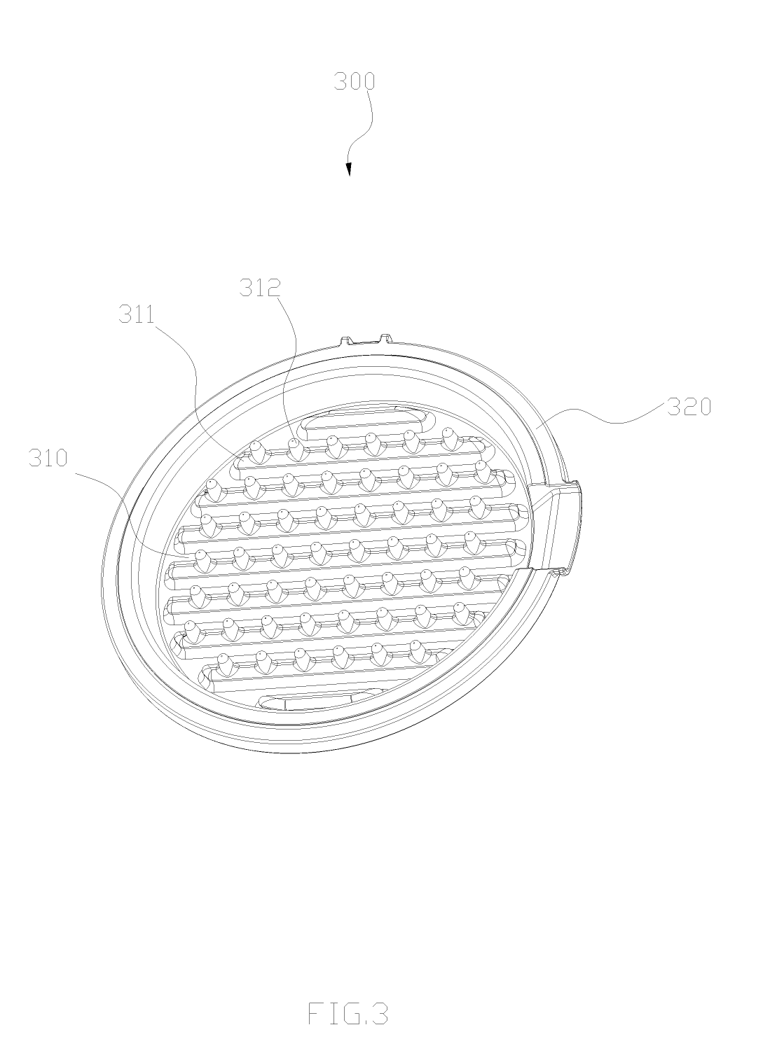

FIG. 4 is a perspective view of the lower baking pan of the grill of the first preferred embodiment.

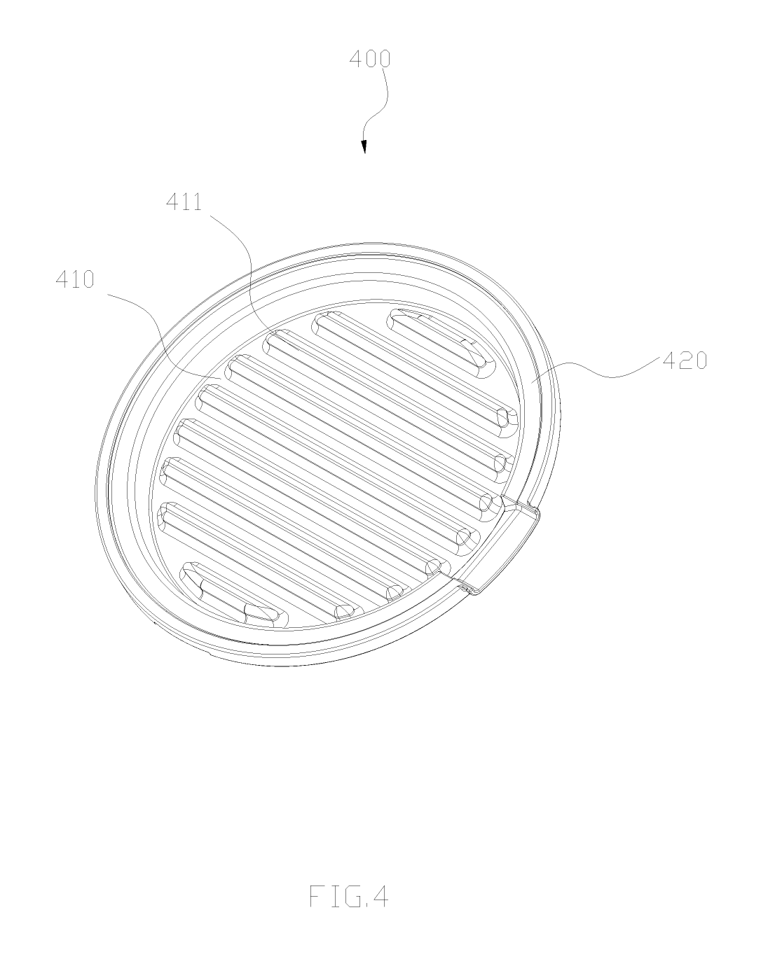

FIG. 5 is a perspective view of the upper baking pan and the lower baking pan of the grill of the first preferred embodiment in close state.

FIG. 6 is a perspective view of the grill of the second preferred embodiment.

FIG. 7 is a perspective view of the grill of the third preferred embodiment.

FIG. 8 is a perspective view of the grill of the fourth preferred embodiment.

FIG. 9 is a perspective view of the grill of the fifth preferred embodiment.

FIG. 10 is a perspective view of the grill of the sixth preferred embodiment.

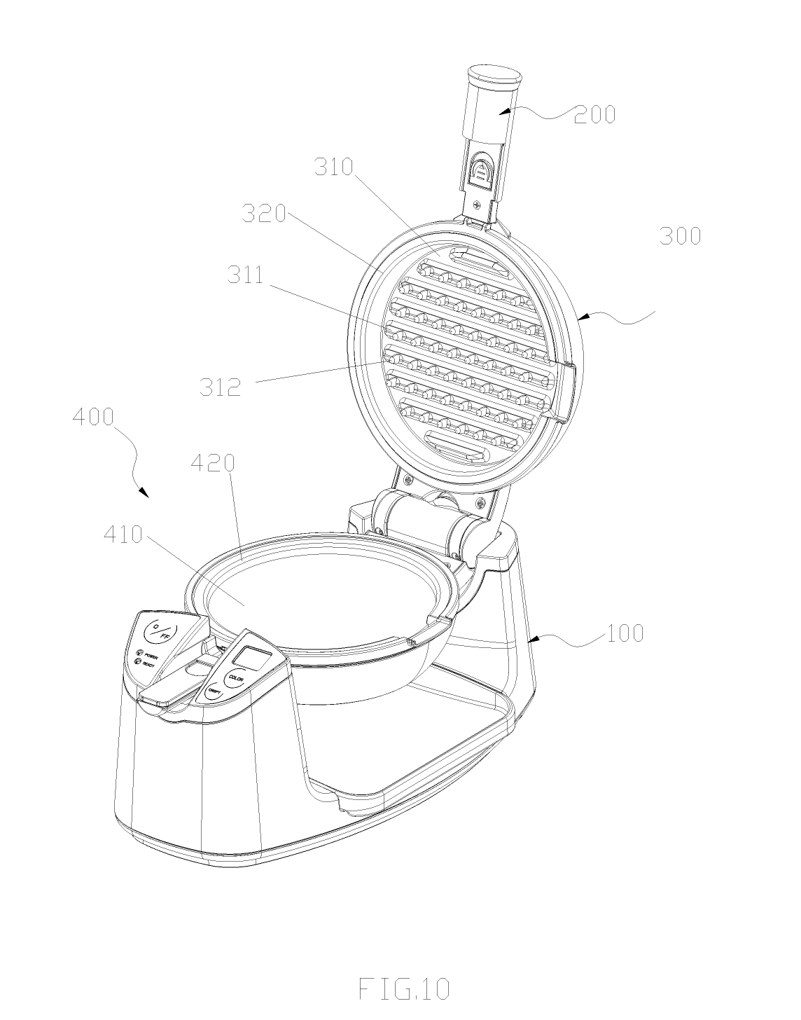

FIG. 11 is a perspective view of the grill of the seventh preferred embodiment.

FIG. 12 is a perspective view of the grill of the eighth preferred embodiment.

FIG. 13 is a perspective view of the grill of the ninth preferred embodiment.

FIG. 14 is a perspective view of the grill of the tenth preferred embodiment.

FIG. 15 is a perspective view of the grill of the eleventh preferred embodiment.

FIG. 16 is a perspective view of the grill of the twelfth preferred embodiment.

label declaration: base body 100, lever unit 200, upper baking pan unit 300, lower baking pan unit 400, first bottom wall 310, first peripheral wall 320, rib 311, convex unit 312, second bottom wall 410, second peripheral wall 420, rib 411.

### DESCRIPTION OF THE PREFERRED EMBODIMENTS

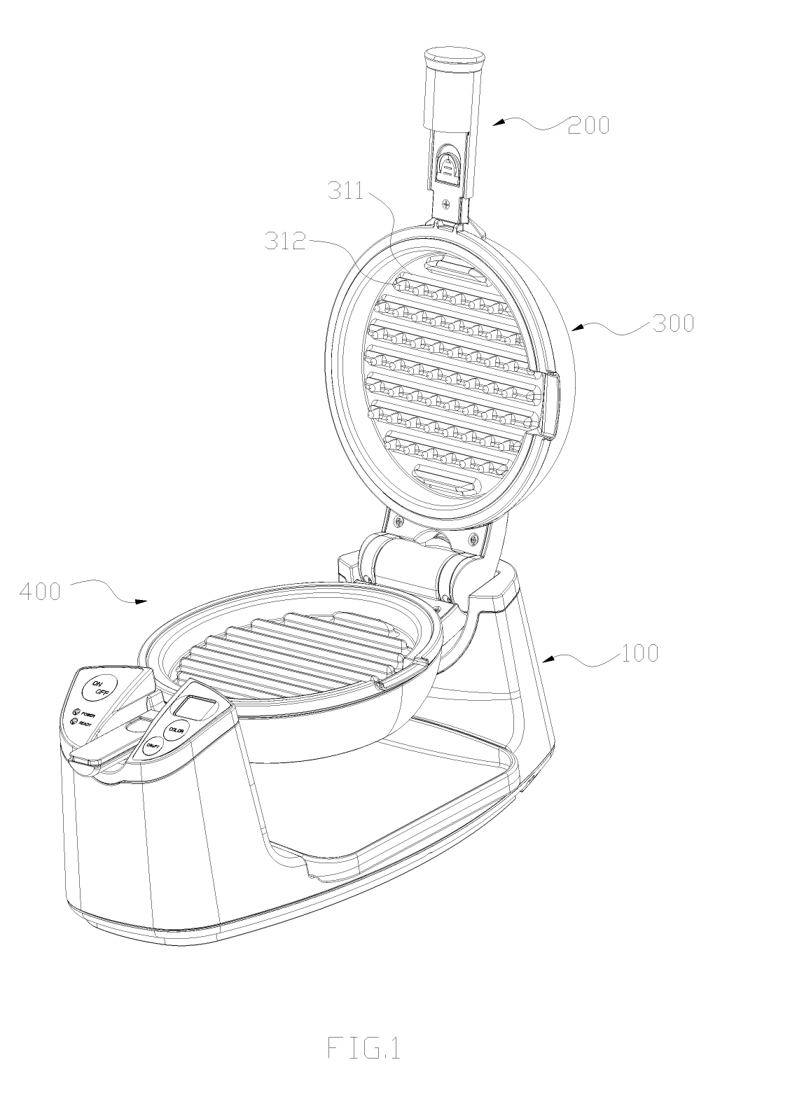

Referring to FIGS. 1,2,3,4, a grill comprising: a base body 100, a lever unit 200, an upper baking pan unit 300, a lower baking pan unit 400, said lever unit 200 is pivotally provided on said base body 100, said upper baking pan unit 300 is set on said lever unit 200, said lower baking pan unit 400 is set on the base body 100, since the construction of assembling between said base body 100 and said lever unit 200, the construction of assembling between said base body 100 and said lower baking pan unit 400, the construction of assembling between said lever unit 200 and said upper baking pan unit 300 are existing technology, will not be further explained,

Said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said convex units 312 are lengthwise disposed on said ribs 311, said convex unit 312 is a cylinder, and the end of said cylinder is tapered. If required, the height of convex unit 312 equals to the height of the rib 311. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said lower heating unit is provided on the back of the second bottom wall 410, used for heating the lower baking pan.

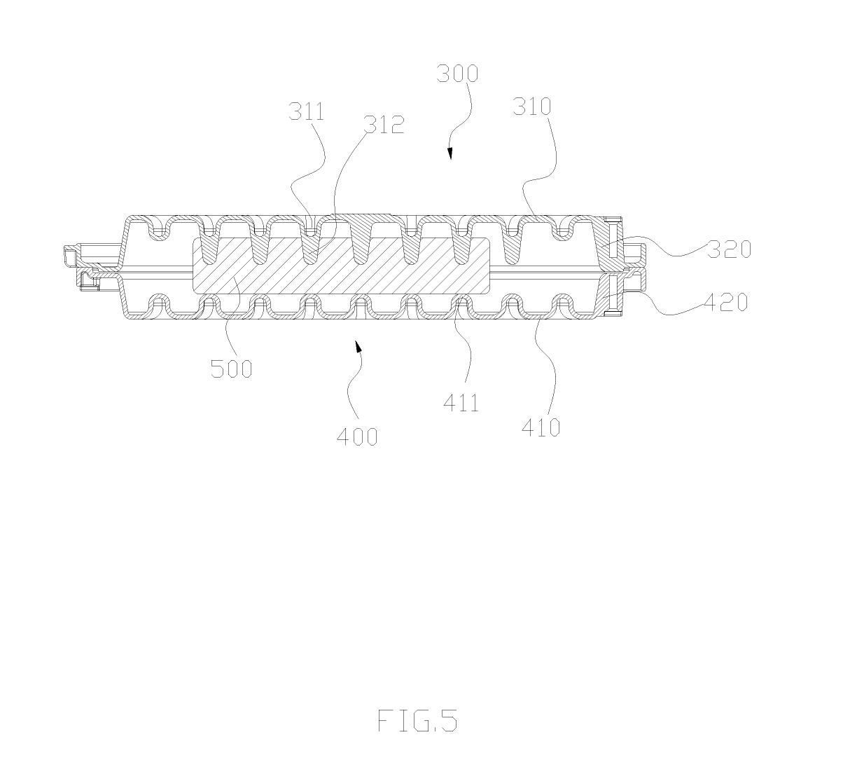

Referring to FIG. 5, the convex units 312 are disposed on the first bottom wall 310, said convex units 312 insert hamburger meat 500 in cooking, and these convex units transmit heat to food, accelerate the cooking time, and we can have a appetizing hamburger meat.

In the second preferred embodiment, the difference differed from the first preferred embodiment:

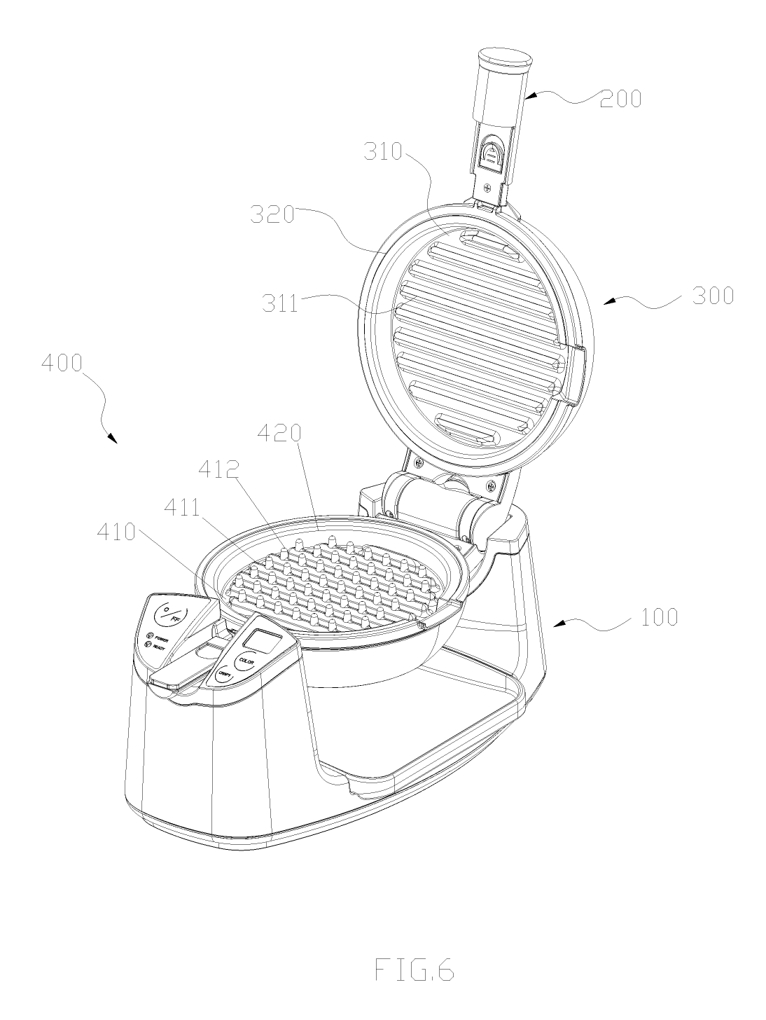

Referring to FIG. 6, said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said convex units 412 are lengthwise disposed on said ribs 411, said convex unit 412 is a cylinder, and the end of said cylinder is tapered. If required, the height of convex unit 412 equals to the height of the rib 411, said lower heating unit is provided on the back of the second bottom wall 410, used for heating the lower baking pan.

In the third preferred embodiment, the difference differed from the first preferred embodiment:

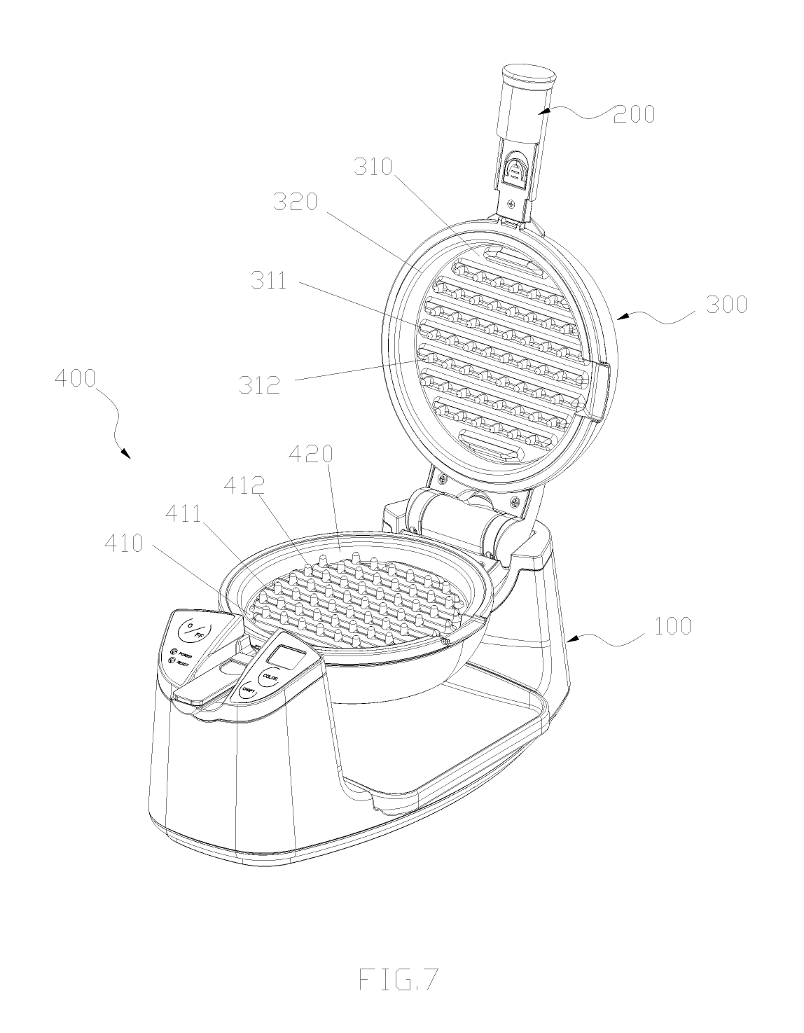

Referring to FIG. 7, said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said convex units 312 are lengthwise disposed on said ribs 311, said convex unit 312 is a cylinder, and the end of said cylinder is tapered. If required, the height of convex unit 312 equals to the height of the rib 311. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said convex units 412 are lengthwise disposed on said ribs 411, said convex unit 412 is a cylinder, and the end of said cylinder is tapered. If required, the height of convex unit 412 equals to the height of the rib 411, said lower heating unit is provided on the back of the second bottom wall 410, used for heating the lower baking pan.

In the fourth preferred embodiment, the difference differed from the first preferred embodiment:

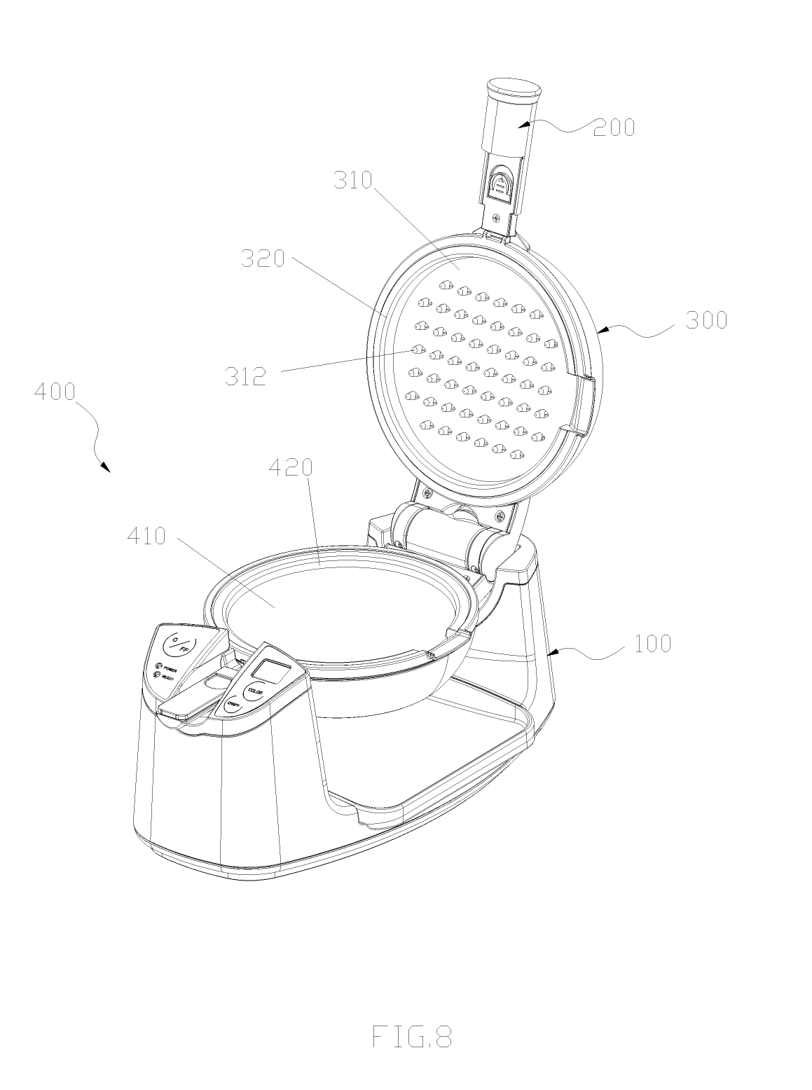

Referring to FIG. 8, said upper baking pan unit 300 comprises: an upper baking pan and an upper heating unit. Said upper baking pan comprises a first bottom wall 310 and a first peripheral wall 320 extended upwardly from the edge of said first bottom wall 310. Said convex units 312 are disposed on said first bottom wall 310. Said convex unit 312 is a cylinder, and the end of said cylinder is tapered. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said lower heating unit is provided on the back of the second bottom wall 410, used for heating the lower baking pan.

In the fifth preferred embodiment, the difference differed from the first preferred embodiment:

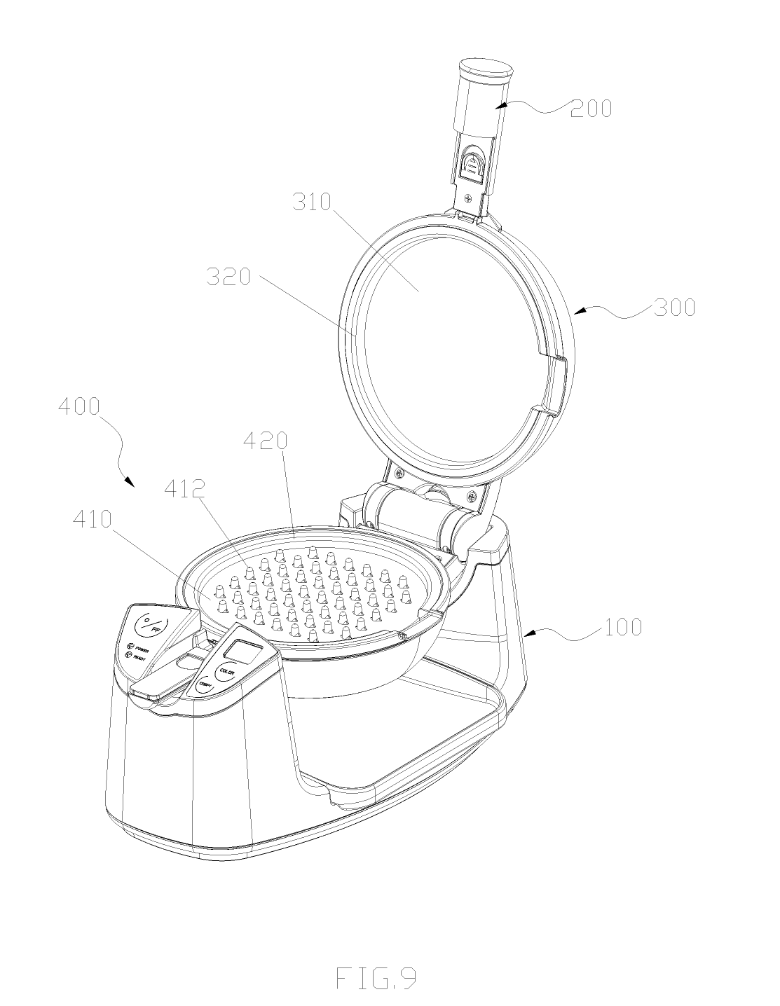

Referring to FIG. 9, said upper baking pan unit 300 comprises: an upper baking pan and an upper heating unit. Said upper baking pan comprises a first bottom wall 310 and a first peripheral wall 320 extended upwardly from the edge of said first bottom wall 310. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said convex units 412 are disposed on said second bottom wall 410. Said convex unit 412 is a cylinder, and the end of said cylinder is tapered. Said lower heating unit is provided on the back of the second bottom wall 410, used for heating the lower baking pan.

In the sixth preferred embodiment, the difference differed from the first preferred embodiment:

Referring to FIGS. 7,10, said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said convex units 312 are lengthwise disposed on said ribs 311, said convex unit 312 is a cylinder, and the end of said cylinder is tapered. If required, the height of convex unit 312 equals to the height of the rib 311. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said lower heating unit is provided on the back of the second bottom wall 410, used for heating the lower baking pan.

In the seventh preferred embodiment, the difference differed from the first preferred embodiment:

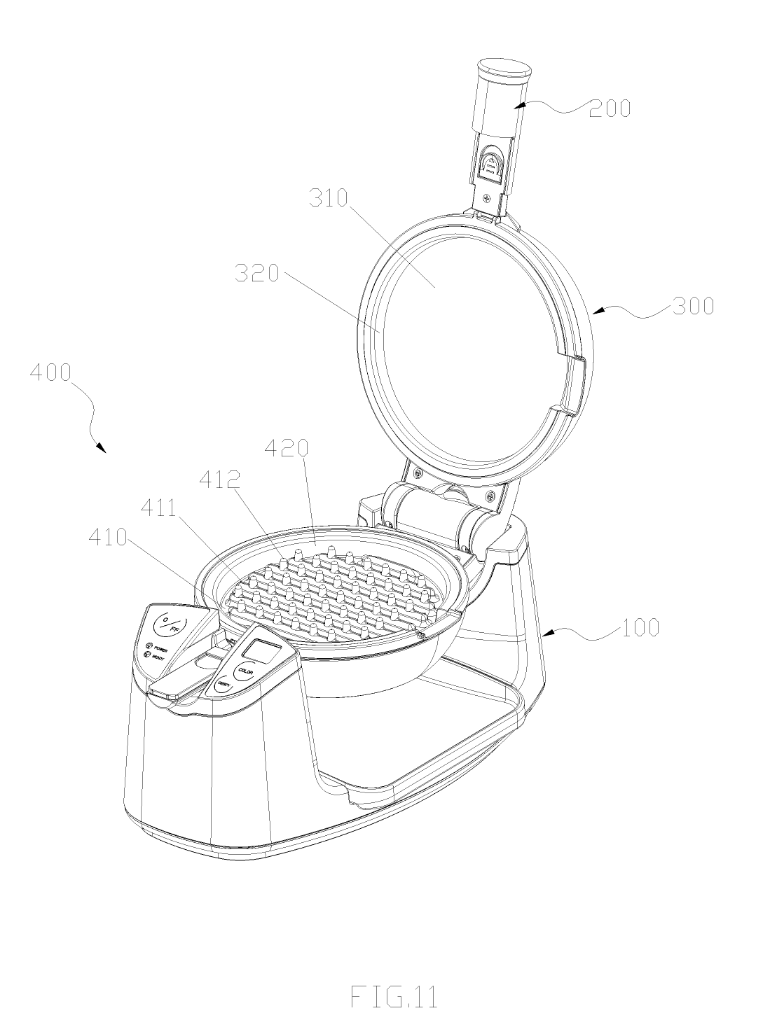

Referring to FIG. 11, said upper baking pan unit 300 comprises: an upper baking pan and an upper heating unit. Said upper baking pan comprises a first bottom wall 310 and a first peripheral wall 320 extended upwardly from the edge of said first bottom wall 310. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said convex units 412 are lengthwise disposed on said ribs 411, said convex unit 412 is a cylinder, and the end of said cylinder is tapered. If required, the height of convex unit 412 equals to the height of the rib 411, said lower heating unit is provided on the back of the second bottom wall 410, used for heating the lower baking pan.

In the eighth preferred embodiment, the difference differed from the first preferred embodiment:

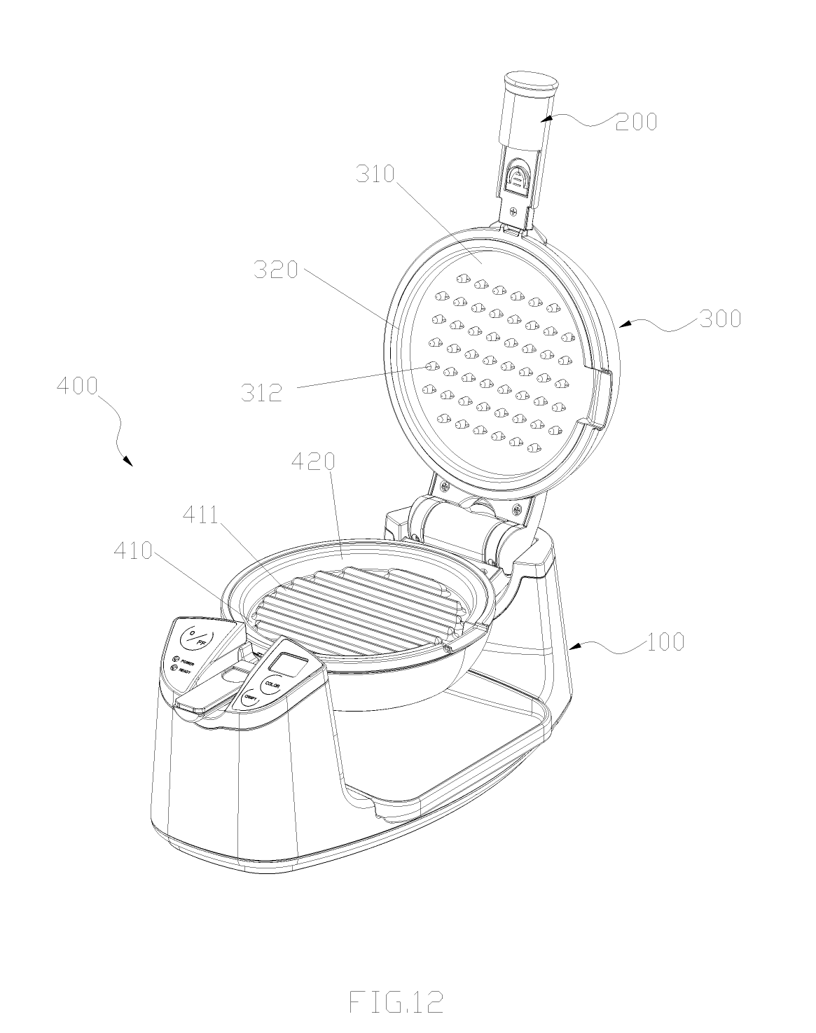

Referring to FIG. 12, said upper baking pan unit 300 comprises: an upper baking pan and an upper heating unit. Said upper baking pan comprises a first bottom wall 310 and a first peripheral wall 320 extended upwardly from the edge of said first bottom wall 310. said convex units 312 are disposed on said first bottom wall 310. Said convex unit 312 is a cylinder, and the end of said cylinder is tapered. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said lower heating unit is provided on the back of the second bottom wall 410, used for heating the lower baking pan.

In the ninth preferred embodiment, the difference differed from the first preferred embodiment:

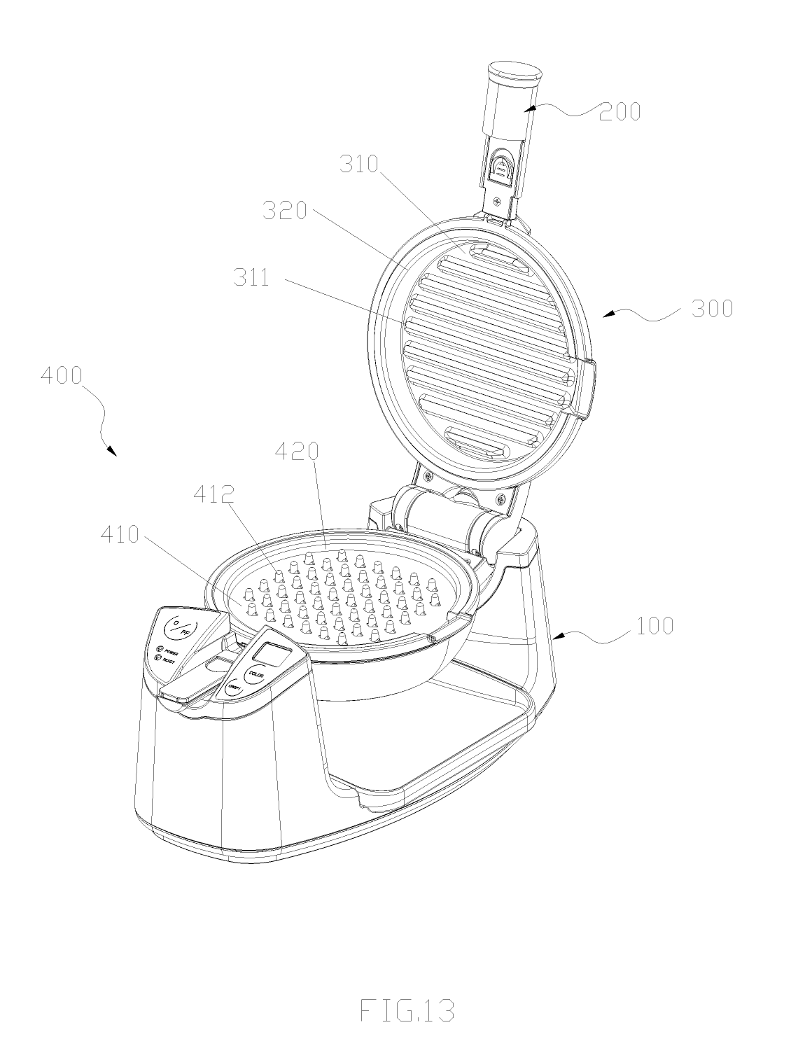

Referring to FIG. 13, said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said convex units 412 are disposed on said second bottom wall 410. Said convex unit 412 is a cylinder, and the end of said cylinder is tapered. Said lower heating unit is provided on the back of the second bottom wall 410, used for heating the lower baking pan.

In the tenth preferred embodiment, the difference differed from the first preferred embodiment:

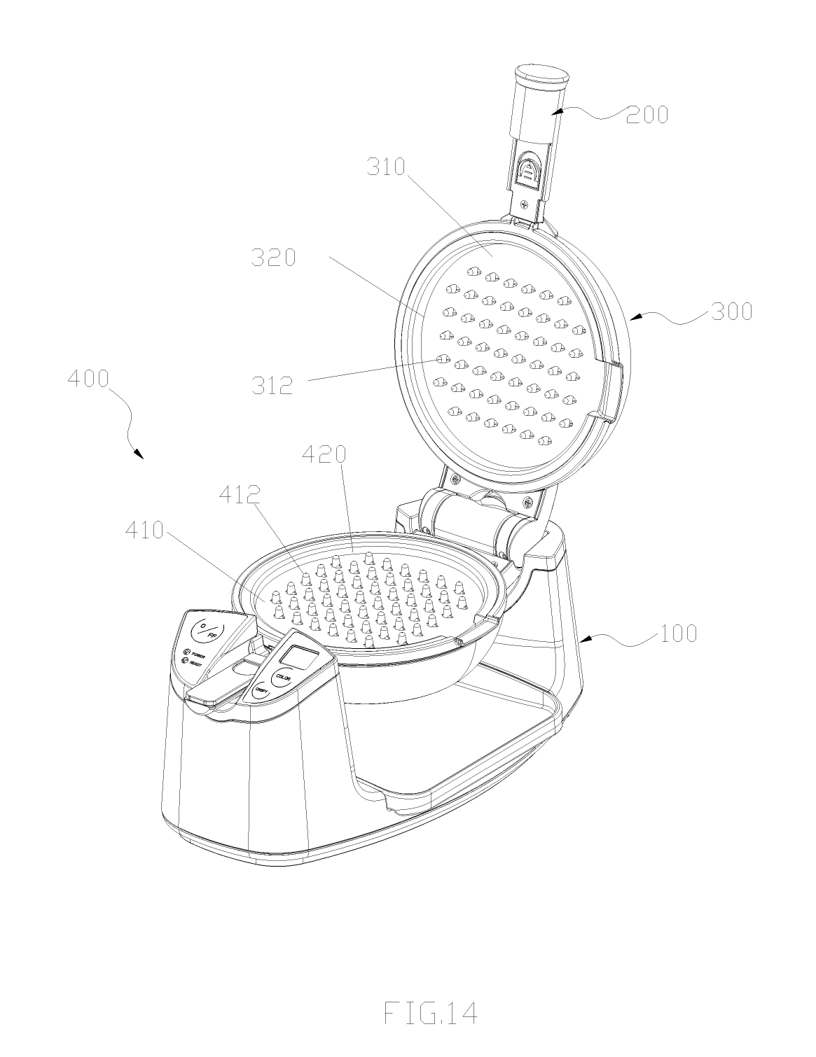

Referring to FIG. 14, said upper baking pan unit 300 comprises: an upper baking pan and an upper heating unit. Said upper baking pan comprises a first bottom wall 310 and a first peripheral wall 320 extended upwardly from the edge of said first bottom wall 310. said convex units 312 are disposed on said first bottom wall 310. Said convex unit 312 is a cylinder, and the end of said cylinder is tapered. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said convex units 412 are disposed on said second bottom wall 410. Said convex unit 412 is a cylinder, and the end of said cylinder is tapered. Said lower heating unit is provided on the back of the second bottom wall 410, used for heating the lower baking pan.

In the eleventh preferred embodiment, the difference differed from the first preferred embodiment:

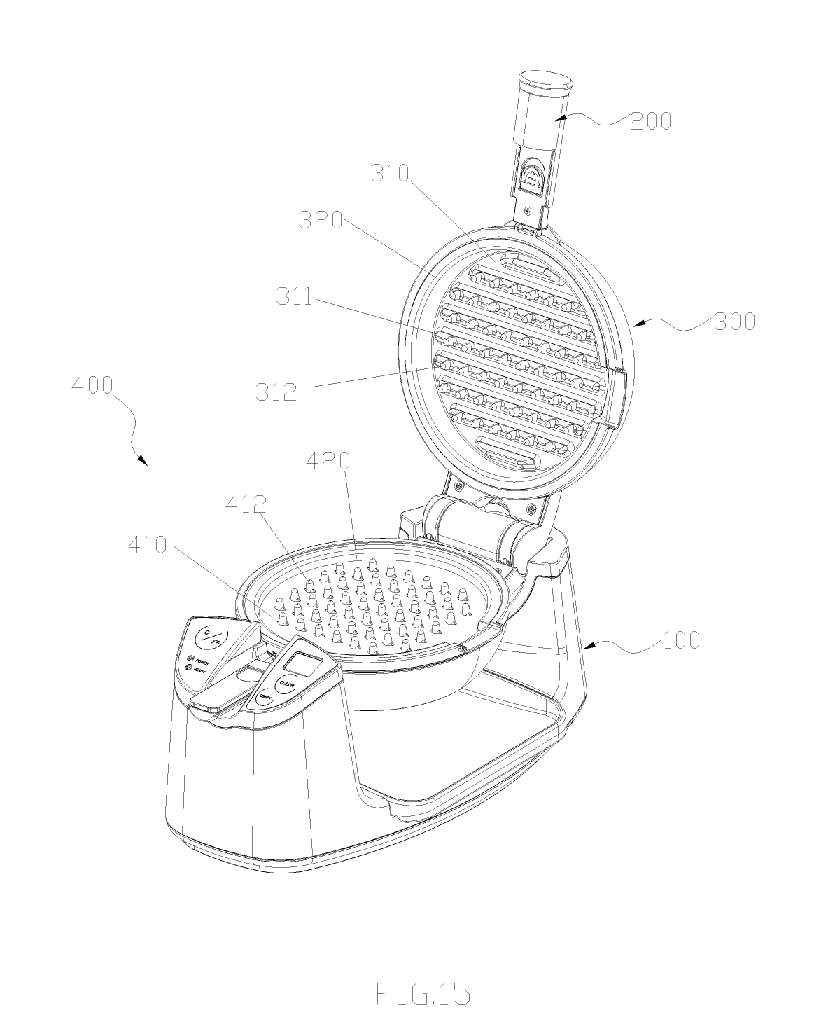

Referring to FIG. 15, Said upper baking pan unit 300 comprises: an upper baking pan and an upper heating unit. Said upper baking pan comprises a first bottom wall 310 and a first peripheral wall 320 extended upwardly from the edge of said first bottom wall 310. Said first bottom wall 310 is into wave shape, so the front surface of said first bottom wall 310 is into wave shape, multiple ribs 311 are disposed at intervals on said front surface, said convex units 312 are lengthwise disposed on said ribs 311, said convex unit 312 is a cylinder, and the end of said cylinder is tapered. If required, the height of convex unit 312 equals to the height of the rib 311. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said convex units 412 are disposed on said second bottom wall 410. Said convex unit 412 is a cylinder, and the end of said cylinder is tapered. Said lower heating unit is provided on the back of the second bottom wall 410, used for heating the lower baking pan.

In the twelfth preferred embodiment, the difference differed from the first preferred embodiment:

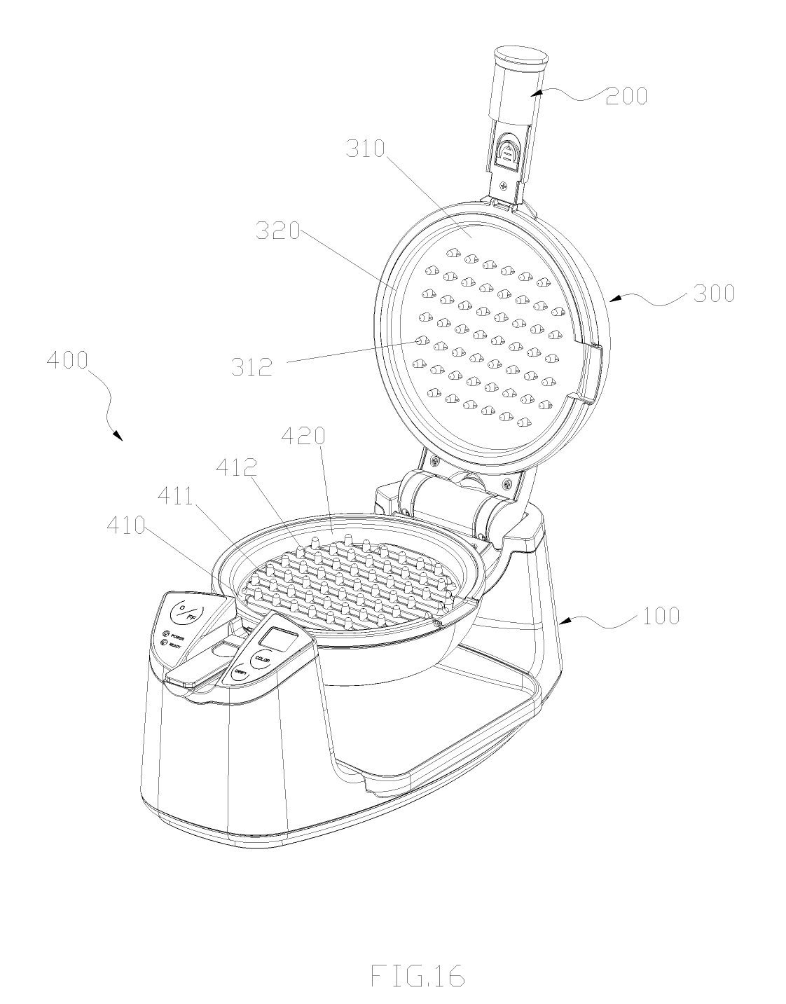

Referring to FIG. 16, said upper baking pan unit 300 comprises: an upper baking pan and an upper heating unit. Said upper baking pan comprises a first bottom wall 310 and a first peripheral wall 320 extended upwardly from the edge of said first bottom wall 310. Said convex units 312 are disposed on said first bottom wall 310. Said convex unit 312 is a cylinder, and the end of said cylinder is tapered. Said upper heating unit is provided on the back of the first bottom wall 310, used for heating the upper baking pan.

Said lower baking pan unit 400 comprises: a lower baking pan and a lower heating unit. Said lower baking pan comprises a second bottom wall 410 and a second peripheral wall 420 extended upwardly from the edge of said second bottom wall 410. Said second bottom wall 410 is into wave shape, so the front surface of said second bottom wall 410 is into wave shape, multiple ribs 411 are disposed at intervals on said front surface, said convex units 412 are lengthwise disposed on said ribs 411, said convex unit 412 is a cylinder, and the end of said cylinder is tapered. If required, the height of convex unit 412 equals to the height of the rib 411, said lower heating unit is provided on the back of the second bottom wall 410, used for heating the lower baking pan.

As mentioned above, the described embodiments are to be considered in all respects only as illustrative and no restrictive. All changes which come within the meaning and range of equivalency of the claims are to be embraced with their scope.

What is claimed is:

1. A grill comprises: an upper baking pan unit and a lower baking pan unit, wherein said upper baking pan unit comprises an upper baking pan, a first bottom wall and a first peripheral wall, and said lower baking pan unit comprises a lower baking pan, a second bottom wall and a second peripheral wall; wherein at least one of said first bottom wall and/or second bottom wall comprises multiple convex units disposed on its front surface.

2. The grill according to claim 1, wherein the front surface of said first bottom wall is into wave shape and comprises multiple ribs disposed at intervals; wherein said convex units are disposed on said ribs uniformly.

3. The grill according to claim 1, wherein the front surface of said second bottom wall is into wave shape and comprises multiple ribs disposed at intervals; wherein said convex units are disposed on said ribs.

4. The grill according to claim 1, wherein the end of said convex unit is tapered.

5. The grill according to claim 1, wherein said convex unit is a cylinder, and the end of said cylinder is tapered.

6. The grill according to claim 2, wherein the front surface of said second bottom wall is into wave shape and is the same as the front surface of said first bottom wall.

7. A grill comprises: a baking pan provided with a bottom wall and a peripheral wall; wherein multiple convex units are disposed at intervals on the front surface of said bottom wall.

8. The grill according to claim 7, wherein the front surface of said bottom wall is into wave shape and comprises multiple ribs disposed at intervals; wherein said convex units are disposed uniformly on said ribs.

9. The grill according to claim 7, wherein the end of said convex unit is tapered.

10. The grill according to claim 7, wherein said convex unit is a cylinder, and the end of said cylinder is tapered.

11. The grill according to claim 7, wherein said baking pan is integrative.
